(19) United States
(12) Patent Application Publication
(10) Pub. No.: US 2014/0279031 A1
(43) Pub. Date: Sep. 18, 2014

(54) MOBILE IN-STORE LOYALTY ADVERTISING AND MARKETING SYSTEM AND METHOD

(71) Applicant: Randy MERSKY, Silver Spring, MD (US)

(72) Inventor: Randy MERSKY, Silver Spring, MD (US)

(21) Appl. No.: 14/209,269

(22) Filed: Mar. 13, 2014

Related U.S. Application Data
(60) Provisional application No. 61/782,737, filed on Mar. 14, 2013.

(51) Int. Cl. G06Q 30/02

(52) U.S. Cl. CPC G06Q 30/0267
USPC 705/14.64

(57) ABSTRACT

Systems, methods, and media for providing an electronic messaging system in a retail environment are provided. An electronic message board is created in association with a retailer. The electronic message board is accessible in the retail environment and includes a host advertisement. The host advertisement is determined in association with the retailer from a host advertisement database that includes advertisements of indirect advertisers obtained by the host server. The retailer is provided with retailer access controls which enable the retailer to access and control a content of the electronic message board. The retailer access controls further enable the retailer to provide advertiser access controls to a direct advertiser obtained by the retailer. The advertiser access controls enable the direct advertiser to also access and control the content of the electronic message board, and are different than the retailer access controls.

### CROSS-REFERENCE TO RELATED APPLICATION

The present application claims the benefit of provisional application U.S. Pat. Appl. No. 61/782,737, filed on Mar. 14, 2013, the disclosure of which, including the specification and figures, is incorporated herein by reference in its entirety.

### BACKGROUND

1. Field of the Disclosure The present disclosure generally relates to the field of loyalty advertising. More particularly, the present disclosure relates to various systems, methods, and media for providing in-store advertising, marketing, and loyalty to consumers on their mobile devices.

2. Background Information

There are a number of companies that currently offer programs for retailers to offer advertisements, coupons, points, and other rewards to customers that “check-in to a store” via their mobile devices. These companies use different methods for the “check-in” or “opt-in” process, but the goal is typically to push advertisements or rewards of some kind to the customers in the store via their mobile devices.

The traditional business model includes a processor which charges the retailer or participating brand for “kicks” or rewards pushed to the customers. The benefit to the retailer or participating brand is, in theory, more incremental sales.

### SUMMARY OF THE DISCLOSURE

The present disclosure, through one or more of its various aspects, embodiments, and/or specific features or sub-components, provides, inter alia, various systems, servers, methods, media, and programs for a mobile in-store customer loyalty advertising and marketing system.

According to a non-limiting embodiment of the present disclosure, a host server for providing an electronic messaging system in a retail environment is provided. The host server includes a host processor and a host memory that includes instructions that, when executed by the host processor, cause the host processor to execute operations. The host processor creates an electronic message board in association with a retailer. The electronic message board is stored in a message board database and is accessible in the retail environment to a consumer via a log-in process. The host processor determines a host advertisement in association with the retailer. The host advertisement is stored in a host advertisement database that includes advertisements of a plurality of indirect advertisers obtained by the host server. The host advertisement is displayed on the electronic message board. The host processor provides the retailer with retailer access controls which enable the retailer to access and control a content of the electronic message board. The retailer access controls enable the retailer to provide advertiser access controls to a direct advertiser obtained by the retailer. The advertiser access controls enable the direct advertiser to access and control the content of the electronic message board. The advertiser access controls are different than the retailer access controls.

According to one aspect of the present disclosure, the electronic message board comprises a first area that is accessible to the host processor for displaying the host advertisement, and a second area that is accessible to the retailer via the retailer access controls and accessible to the direct advertiser via the advertiser access controls. The retailer and the direct advertiser each control the content of the electronic message board via the second area.

According to another aspect of the present disclosure, the second area of the electronic message board comprises a retailer area that is accessible to the retailer via the retailer access controls, and an advertiser area that is accessible to the direct advertiser via the advertiser access controls. The retailer controls the content of the electronic message board via the retailer area, and the advertiser controls the content of the electronic message board via the advertiser area.

According to yet another aspect of the present disclosure, the advertiser area is further accessible to the retailer via the retailer access controls, with the retailer controlling the content of the electronic message board via the retailer area and the advertiser area.

According to still another aspect of the present disclosure, the advertiser access controls provide the direct advertiser with access to only the advertiser area of the electronic message board for limiting control of the content of the electronic message board by the direct advertiser to only the advertiser area.

According to an additional aspect of the present disclosure, the advertiser area includes a plurality of advertiser areas, the retailer access controls enable the retailer to provide the advertiser access controls to a plurality of direct advertisers obtained by the retailer, and the advertiser access controls of each of the plurality of direct advertisers enable access and control of the content of the electronic message board via a corresponding one of the plurality of advertiser areas.

According to another aspect of the present disclosure, the retailer access controls for the second area are different than the advertiser access controls for the second area.

According to yet another aspect of the present disclosure, the retailer access controls for the second area are equal to the advertiser access controls for the second area.

According to still another aspect of the present disclosure, the retailer access controls enable the retailer to access and control the first area of the electronic message board.

According to an additional aspect of the present disclosure, the retailer access controls provide the retailer with access to only the second area of the electronic message board for limiting control of the content of the electronic message board by the retailer to only the second area.

According to another aspect of the present disclosure, the host processor has access to only the first area of the electronic message board for limiting a display of the host advertisement to only the first area.

According to yet another aspect of the present disclosure, the advertiser access controls enable the direct advertiser to access and control the content of the electronic message board independently of the host server.

According to still another aspect of the present disclosure, the retailer access controls enable the retailer to variably provide the advertiser access controls to the direct advertiser to limit the access and control of the electronic message board by the direct advertiser.

According to an additional aspect of the present disclosure, the advertiser access controls spatially limit the direct advertiser to accessing and controlling a predetermined portion of the electronic message board.

According to another aspect of the present disclosure, the advertiser access controls geographically limit the direct advertiser to accessing and controlling the electronic message board within a predetermined area.

According to yet another aspect of the present disclosure, the advertiser access controls temporally limit the direct advertiser to accessing and controlling the electronic message board during a predetermined period.

According to still another aspect of the present disclosure, the advertiser access controls quantitatively limit the direct advertiser to accessing and controlling the electronic message board a predetermined number of times.

According to yet another aspect of the present disclosure, the advertiser access controls quantitatively limit the content controlled by the advertiser to being accessed by a predetermined number of consumers.

According to an additional aspect of the present disclosure, the host processer notifies the retailer when the content of the electronic message board is modified by the direct advertiser to include a direct advertiser advertisement.

According to another aspect of the present disclosure, the host processer displays the direct advertiser advertisement on the electronic message board only in response to receiving an acceptance of the direct advertiser advertisement from the retailer.

According to yet another aspect of the present disclosure, the host processer displays receives a modification of the direct advertiser advertisement from the retailer after notifying the retailer of the direct advertiser advertisement, and displays the direct advertiser advertisement with the modification on the electronic message board in response to the receiving of the modification.

According to still another aspect of the present disclosure, the electronic message board comprises a plurality of electronic message boards.

According to yet another aspect of the present disclosure, the advertiser access controls provide each of a plurality of direct advertisers with access and control to one of the plurality of electronic message boards.

According to an additional aspect of the present disclosure, the host processer receives an access request from the consumer via the log-in process, and provides the electronic message board including the host advertisement and the content controlled by the retailer and the direct advertiser to the consumer in response to the receiving of the access request.

According to another aspect of the present disclosure, the host processer authenticates the access request from the consumer using consumer information stored in a consumer information database.

According to yet another aspect of the present disclosure, the retailer access controls further provide access to the consumer information database.

According to still another aspect of the present disclosure, the host processer displays a loyalty reward for the consumer on the electronic message board in response to the receiving of the access request.

According to yet another aspect of the present disclosure, the loyalty reward is displayed on the electronic message board in response to the receiving of the access request and after a determination that a predetermined condition is satisfied.

According to still another aspect of the present disclosure, the host processor tracks a display of the host advertisement and the control of the content of the electronic message board by each of the retailer and the direct advertiser for determining an advertising flow through the electronic message board.

According to another non-limiting embodiment of the present disclosure, a method for providing an electronic messaging system in a retail environment is provided. The method includes the features of creating an electronic message board in association with a retailer, and storing the electronic message board in a message board database. The electronic message board is accessible in the retail environment to a consumer via a log-in process. The method further determines, with a processor, a host advertisement in association with the retailer. The host advertisement is stored in a host advertisement database that includes advertisements of a plurality of indirect advertisers obtained by the host server. The method displays the host advertisement on the electronic message board, and provides the retailer with retailer access controls which enable the retailer to access and control a content of the electronic message board. The retailer access controls enable the retailer to provide advertiser access controls to a direct advertiser obtained by the retailer. The advertiser access controls enable the direct advertiser to access and control the content of the electronic message board, and the advertiser access controls are different than the retailer access controls.

According to an aspect of the present disclosure, the electronic message board of the method comprises a first area that is accessible to the host processor for displaying the host advertisement, and a second area that is accessible to the retailer via the retailer access controls and accessible to the direct advertiser via the advertiser access controls. The retailer and the direct advertiser each control the content of the electronic message board via the second area.

According to yet another non-limiting embodiment of the present disclosure, a non-transitory computer readable medium is provided. The non-transitory computer readable medium includes an executable set of instructions for providing an electronic messaging system in a retail environment that, when executed by a processor, causes the processor to execute operations. The processor creates an electronic message board in association with a retailer, and stores the electronic message board in a message board database. The electronic message board is accessible in the retail environment to a consumer via a log-in process. The processor determines a host advertisement in association with the retailer. The host advertisement is stored in a host advertisement database that includes advertisements of a plurality of indirect advertisers obtained by the host server. The processor displays the host advertisement on the electronic message board, and provides the retailer with retailer access controls which enable the retailer to access and control a content of the electronic message board. The retailer access controls enable the retailer to provide advertiser access controls to a direct advertiser obtained by the retailer. The advertiser access controls enable the direct advertiser to access and control the content of the electronic message board, and the advertiser access controls are different than the retailer access controls.

According to an aspect of the present disclosure, the electronic message board of the non-transitory computer readable medium includes a first area that is accessible to the host processor for displaying the host advertisement, and a second area that is accessible to the retailer via the retailer access controls and accessible to the direct advertiser via the advertiser access controls. The retailer and the direct advertiser each control the content of the electronic message board via the second area.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary system for providing an electronic messaging system in a retail environment.

FIGS. 2A and 2B illustrate a schematic of an exemplary system for providing an electronic messaging system in a retail environment.

FIG. 3 illustrates an exemplary system for providing an electronic messaging system in a retail environment.

FIG. 4 illustrates a schematic of exemplary components of an electronic messaging system.

FIG. 5 illustrates an exemplary embodiment of a profile of a retailer in an electronic messaging system.

FIG. 6 illustrates an exemplary embodiment of an entry of a retailer in an electronic message board database.

FIG. 7 illustrates an exemplary embodiment of an entry of a consumer in a consumer information database.

FIG. 8 illustrates an exemplary embodiment of an electronic message board.

FIG. 9 illustrates an exemplary embodiment of an electronic message board creation process accessible to a retailer in an electronic messaging system.

FIG. 10 illustrates an exemplary embodiment of an electronic message board administration process accessible to a retailer in an electronic messaging system.

FIG. 11 illustrates an exemplary embodiment of a direct advertiser administration process accessible to a retailer in an electronic messaging system.

FIG. 12 illustrates an exemplary embodiment of a direct advertiser message board history process accessible to a retailer in an electronic messaging system.

FIG. 13 illustrates an exemplary embodiment of a rewards administration process accessible to a retailer in an electronic messaging system.

FIG. 14 illustrates an exemplary embodiment of a consumer information process accessible to a retailer in an electronic messaging system.

FIG. 15 illustrates an exemplary embodiment of an electronic message board creation process accessible to a direct advertiser in an electronic messaging system.

FIG. 16 illustrates an exemplary process for providing an electronic messaging system in a retail environment.

FIG. 17 illustrates an exemplary schematic of an electronic message board provided in a retail environment.

FIG. 18 illustrates a further exemplary schematic of an electronic message board provided in a retail environment.

### DETAILED DESCRIPTION

The present disclosure, through one or more of its various aspects, embodiments and/or specific features or sub-components, is thus intended to bring out one or more of the advantages as specifically noted below.

FIG. 1 is an exemplary system for use in accordance with the embodiments described herein. The system 100 is generally shown and may include a computer system 102, which is generally indicated. The computer system 102 may operate as a standalone device or may be connected to other systems or peripheral devices. For example, the computer system 102 may include, or be included within, any one or more computers, servers, systems, communication networks or cloud environment.

The computer system 102 may operate in the capacity of a server in a network environment, or the in the capacity of a client user computer in the network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless telephone, a personal trusted device, a web appliance, or any other machine capable of executing a set of instructions (sequential or otherwise) that specify actions to be taken by that device. Further, while a single computer system 102 is illustrated, addition embodiments may include any collection of systems or sub-systems that individually or jointly execute instructions or perform functions.

As illustrated in FIG. 1, the computer system 102 may include at least one processor 104, such as, for example, a central processing unit, a graphics processing unit, or both. The computer system 102 may also include a computer memory 106. The computer memory 106 may include a static memory, a dynamic memory, or both. The computer memory 106 may additionally or alternatively include a hard disk, random access memory, a cache, or any combination thereof. Of course, those skilled in the art appreciate that the computer memory 106 may comprise any combination of known memories or a single storage.

As shown in FIG. 1, the computer system 102 may include a computer display 108, such as a liquid crystal display, an organic light emitting diode, a flat panel display, a solid state display, a cathode ray tube, a plasma display, or any other known display.

The computer system 102 may include at least one computer input device 110, such as a keyboard, a remote control device having a wireless keypad, a microphone coupled to a speech recognition engine, a camera such as a video camera or still camera, a cursor control device, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 and a network interface 114. Furthermore, the computer system 102 may include any additional devices, components, parts, peripherals, hardware, software or any combination thereof which are commonly known and understood as being included with or within a computer system, such as, but not limited to, an output device 116. The output device 116 may be, but is not limited to, a speaker, an audio out, a video out, a remote control output, a printer, or any combination thereof.

Each of the components of the computer system 102 may be interconnected and communicate via a bus 118. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, or any other network commonly known and understood in the art. The network 122 is shown in FIG. 1 as a wireless network. However, those skilled in the art appreciate that the network 122 may also be a wired network.

The additional computer device 120 is shown in FIG. 1 as a personal computer. However, those skilled in the art appreciate that, in alternative embodiments of the present application, the device 120 may be a laptop computer, a tablet PC, a personal digital assistant, a mobile device, a palmtop computer, a desktop computer, a communications device, a wireless telephone, a personal trusted device, a web appliance, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

An exemplary schematic of a system for providing an in-store loyalty advertising and marketing system is generally shown at 200 in FIGS. 2A and 2B. The system 200 is shown as defining relationships between a host server 202, a retailer 204, direct advertisers 206, and indirect advertisers 208. The entities may utilize and collaborate around an electronic message board for use with the in-store loyalty advertising and marketing system.

According to a non-limiting and exemplary embodiment, the host server 202 may have pre-existing or independent relationships with the indirect advertisers 208. Since the host processor 202 is in the business of providing electronic message boards and advertising, the independent or pre-existing relationships of the host processor 202 with the indirect advertisers 208 may be super brand relationships. In this regard, the retailer 204 may be incentivized to establish a relationship with the host server 202 to gain access to the super brand relationships of the host server 202, and to also benefit from an electronic message board being hosted and generally supported or maintained by the host server 202. The host server 202 may be incentivized to establish a relationship with the retailer 204 to gain access to the consumers and customers of the retailer 204, and to also gain advertising access to the retail environment of the retailer 204.

Either of the host server 202 or the retailer 204 may compensate or provide a benefit to the other of the host server 202 and the retailer 204 in exchange for establishing the relationship in accordance with any known and understood means in the art. For example, as in traditional systems, the host server 202 may charge the retailer 204 for “kicks” or rewards pushed to the consumers or customers of the retailer 204. The benefit to the retailer 204 may be, for example, support for an electronic message board and the resultant incremental sales. This is a decent business model, but it is deficient in several ways, which the system 200 of FIGS. 2A and 2B attempts to improve upon.

Notwithstanding the incremental sales, the retailer 204 may lose out on the opportunity to derive any or additional ad revenue itself. In addition, establishing the relationship with the host server 202 may be costly for the retailer 204. The relationship may be cost effective for large retail brands and chains, but it may be difficult to manage and justify for the millions of small retail business owners. Also, it may be more difficult for the small business owners to predict or realize the incremental sales growth. Of course, these scenarios and deficiencies are merely exemplary and are not limiting or exhaustive.

The system 200 of FIGS. 2A and 2B provides the relationship between the retailer 204 and the direct advertisers 206 in view of the above-listed, exemplary and non-limiting scenarios and deficiencies. The system 200 of FIGS. 2A and 2B offers a cost effective, revenue producing system to retailers of all sizes. The system 200 establishes plural relationships among the host server 202, the retailer 204, and the direct advertisers 206. The relationships of the system 200 are shown in FIG. 2A as comprising a triangulation between the host server 202, the retailer 204, and the direct advertisers 206. In the embodiment of the system 200 as shown in FIG. 2B, the relationships between the host server 202, the retailer 204, and the direct advertisers 206 are linear. In other words, in the embodiment of FIG. 2B, the retailer 204 may act as an intermediary between the host server 202 and the direct advertisers 206 to both insulate the retailer's relationship with the direct advertisers 206 from the host server 202, and to also shield the host server 202 from the direct advertisers 206.

In any event, one aspect of the system 200 is that the retailer 204 has control to push rewards or content to the customers or consumers from each of itself, its direct advertisers 206, and the indirect advertisers 208 associated with the host server 202. By having this control, the retailer 204 may derive direct ad revenue from several sources, including the direct advertisers 206, by “renting out” its message board that its consumers or customers have access to, such as when the consumers or customers “opt in” to the message board of the retailer 204. Therefore, not only does the retailer 204 gain incremental sales revenue from the indirect advertisers 208 of the host server 202, and also the direct advertisers 206, it also gains direct advertising revenue from multiple sources, including the direct advertisers 206.

As will be discussed in more detail herein, this is accomplished by providing an open architecture messaging board system that allows controlled access by each party. For example, in one non-limiting and exemplary embodiment, the retailer 204 may designate or provide the direct advertisers 206, with which it has direct relationships, with access to its messaging board system. The retailer 204 may rent space to each direct advertiser 206 by a number of times the direct advertiser 206 wants to push rewards during the week, time of day to push ads, financial strength, etc.

Also, the retailer 204 can allow the host server 202 to push rewards at its location based on its super brand relationships it may have established with the indirect advertisers 208. By having the open architecture, the indirect advertisers 208 and the host server 202 can have access and push their rewards at convenient times and convenient web interfaces. The messaging system may alert the retailer 204 when rewards or advertisements are delivered, and provide the retailer 204 with access and control to modify and release the rewards or advertisements to its consumers or customers.

Also as described in more detail herein, associated with all of this may be an associated accounting and billing system for the retailer 204 which tracks the reward or advertising flow.

In addition to the above, the host server 202 benefits by hosting the messaging system for the retailer 204, and subsequently may charge for that service. It may also derive advertising revenue by establishing a vast network of multiple retail outlets. It may sell advertising space of the retail outlets to brands that would like additional distribution to a large number or variety of retail outlets. The retail outlets, themselves, may also gain a cut or share of the host server 202 super brand advertising revenue.

The above-described examples, embodiments, and effects are merely exemplary and provided for illustrative purposes. The examples, embodiments, and effects are not to be considered limiting or exhaustive. Additional examples, embodiments, and effects are further described below, and even further examples, embodiments, and effects should become apparent from the present application when considered in its entirety.

A further embodiment of a system for providing an electronic messaging system is generally shown at 300 in FIG. 3. The electronic messaging system 300 is shown in FIG. 3 as including a host server 302, a retailer 304, a direct advertiser 306, and a consumer 308. The host server 302, the retailer 304, the direct advertiser 306, and the consumer 308 interact via a network 310. In this regard, the host server 302, the retailer 304, and the direct advertiser 306 may each provide advertisements or rewards to the consumer 308 in a retail environment in which the consumer 308 connects to the network 310.

The electronic messaging system 300 is generally described herein as providing an electronic message board in a retail environment. Nevertheless, it is to be known and understood that the electronic messaging system 300 or the electronic message board is not limited to being used in a retail environment. The electronic messaging system 300 may, for example, provide the electronic message board in any commercial, educational, entertainment, or other environment without departing from the scope of the present disclosure.

The electronic messaging system 300 is also generally described herein as providing advertisements and loyalty rewards for consumers and customers. The electronic messaging system 300 is generally described as being a one-way messaging system. Nevertheless, in further embodiments of the present disclosure, the electronic messaging system 300 may be a two-way messaging system which includes additional contents besides advertisements and loyalty rewards. For example, the electronic messaging system 300 may comprise a quality of service system in which the electronic message board is provided for customer support. The electronic message board may comprise two-way messaging with any of the host server 302, the retailer 304, and the direct advertiser 306. The electronic message board may also limit two-way messaging to any of the host server 302, the retailer 304, and the direct advertiser 306. The two-way messaging may be initiated via the electronic message board based on areas which are assigned to each of the host server 302, the retailer 304, and the direct advertiser 306. The areas will be described in more detail herein.

The host server 302 is a host or provider of the electronic messaging board. The host server 302 is generally indicated in FIG. 3 and shown as being a general purpose server or computer. The host server 302 may be the same or similar to the computer system 102 as described with respect to FIG. 1. The host server 302 is shown as including a network interface 312 for sending and receiving communications via the network 310, a processor 314, and a memory 316. The processor 314 may be a single processing unit, or comprise a plurality of processing units. For example, the processor 314 may include a distinct central processing unit and a distinct graphics processing unit. Similarly, the memory 316 may be a single memory unit, or comprise a plurality of memory units. For example, the memory 316 may include various combinations of a hard disk, a random access memory module, a cache, and an optical disk. The processor 314 and the memory 316 may be similar to, for example, the processor 104 and the memory 106 as described with respect to FIG. 1. Of course, the above-mentioned examples are merely meant to be exemplary and are not to be limiting. Moreover, it is to be known and understood that the host server 302 is not limited to including the shown components and that the host server 302 may include any additional or alternative components as described with respect to the computer system 102 of FIG. 1, or as otherwise known and understood in the art.

The host server 302 is shown in FIG. 3 as being an integrated system. Nevertheless, in further embodiments of the present application, the host server 302 may comprise a component or distributed system. The features and/or components of the host server 302 may be locally distributed, or the features and/or components may be distributed across a network. The features and/or components of the host server 302 may be controlled or managed by a single entity, or control and management of the features and/or components of the host server 302 may be distributed amongst multiple entities. For example, the memory 316 may be managed by a “cloud” storage provider.

The retailer 304 may engage in a relationship or agreement with the host server 302, financial or otherwise, to obtain the benefits of the electronic messaging board. The retailer 304 is shown as being a general purpose computer. The retailer 304 may be, or be similar to, the computer system 102 or the computer device 120 of FIG. 1. The retailer 304 may include any combination of components as described with respect to the computer system 102 of FIG. 1, or any additional or alternative combinations of components as generally known and understood in the art. The retailer 304 is described herein in singular form. However, it should be known and understood that the host server 302 may provide services for a plurality of retailers 304. Moreover, the term retailer as used herein is not limited to being a person or individual, but rather, may refer to specific, tangible devices or apparatuses which may be used by such a person or individual.

The retailer 304 is generally described and referred to herein as being a “retailer” for clarity and simplicity. However, it should be known and understood that the retailer 304 is not limited to solely being a “retailer.” That is, the retailer 304 may, but need not necessarily, be involved in the sale of goods and/or services to an end user. The retailer 304 may comprise a wholesaler or manufacturer. In even further embodiments, the retailer 304 need not even be involved in the sale of goods and/or services and may comprise any individual or entity which has the need, want, or desire to establish an electronic message board, as described herein. The electronic message board is not limited to being provided for commercial purposes, but may also be provided for any additional or alternative purpose such as, but not limited to, educational, informative, or entertainment purposes.

The retailer 304 may further engage in a relationship or agreement with the direct advertiser 306, financial or otherwise, whereby the direct advertiser 306 is provided with access to the electronic messaging board of the retailer 304 such that the direct advertiser 306 may advertise its content on the electronic messaging board of the retailer 304. The direct advertiser 306 may be any individual or entity which desires to extend an advertisement, loyalty reward, marketing materials, or other content to the consumer 308 via the electronic message board. The direct advertiser 306 may also be referred to as a vendor. The direct advertiser 306 is generally described herein in singular form. Nevertheless, it should be known and understood that the direct advertiser 306 may comprise a plurality of direct advertisers 306.

The consumer 308 accesses the electronic messaging board in the retail environment for receiving the content thereon, including, for example, the advertisements and loyalty rewards. The consumer 308 is shown in FIG. 3 as being a cellular telephone. This illustration of the consumer 308 is merely exemplary and is not intended to be limiting. The consumer 308 may additionally or alternatively be any device which is capable of communicating with the electronic message board via the network 310. For example, the consumer 308 may be the same or similar to the computer system 102 or the one or more additional computer devices 120, as described with respect to FIG. 1, and comprise any combination of the non-limiting and exemplary devices discussed with respect thereto. Moreover, the term consumer as used herein is not limited to being a specific, tangible device or apparatus which may be used by a consumer, but rather, may also refer to an individual consumer itself. In addition, the consumer 308 is generally described herein as being a consumer or customer of the retailer 304. Nevertheless, it should also be known and understood that the described consumer 308 is not limited to such, and that it may additionally or alternatively comprise any additional or alternative individual or entity without departing from the scope of the present application. The consumer 308 is generally described herein in singular form. Nevertheless, it should be known and understood that the consumer 308 may comprise a plurality of consumers 308.

The consumer 308 accesses the electronic message board in the retail environment via the network 310. The network 310 is shown as being similar to the network 122 of FIG. 1. In this regard, the network 310 may include any of the non-limiting and exemplary networks discussed with respect to the network 122 of FIG. 1, and may additionally or alternatively include any other network that is known and understood in the art.

According to an embodiment of the system 300, the host server 302 administers and provides the electronic message board. The host server 302 may administer and provide the electronic message board via a collection of components or processes, which is generally indicated at 400 in FIG. 4. The processes 400 may each be hosted and maintained by the host server 302. Any of the retailer 304, direct advertiser 306, and consumer 308 may access the host server 302 for performing their respective functions as described herein. Alternatively, the various processes 400 may be provided by the host server 302 to any of the retailer 304, the direct advertiser 306, and the consumer 308, whereupon the retailer 304, the direct advertiser 306, and the consumer 308 may maintain and execute functions of the various processes 400 independently of the host server 302. For example, the consumer 308 may access an electronic message board by visiting a website which is hosted by the host server 302, or the consumer 308 may access an electronic message board of the electronic messaging system 300 via a mobile application which is installed by the consumer 308.

The processes 400 may include a host server administration process 402. The host server 302 establishes relationships with indirect advertisers and maintains these relationships in a host advertisement database 318, as shown in FIG. 3. The host server 302 may maintain the host advertisement database 318 in accordance with any known and understood means in the art such that the host server 302 may determine advertisements, loyalty rewards, or any other “kicks” in association with the retailer 304. The host server administration process 402 may comprise a scheduler for determining a schedule or release time of the advertisements, loyalty rewards, or any other “kicks” to the message board.

The host server administration process 402 may also comprise an administration access procedure whereby the host server 302 is able to access the electronic messaging system 300. The administration access procedure may include a secure sign-in process. Upon a successful sign-in, various options may be presented such as, but not limited to, options for accessing, listing, selecting, or otherwise viewing the enrolled retailers, enrolled customers, and/or active, pending, or closed electronic message boards.

In accessing or otherwise viewing the enrolled retailers, the host server 302 may be able to select a retailer name to view any content or activity of the retailer 304. A non-limiting and exemplary embodiment of a profile of a retailer 304 is generally shown at 500 in FIG. 5. The host server 302 may also be able to add or delete enrolled retailers. The enrolled retailers may be stored in a retailer database 320, as shown in FIG. 3. The retailer database 320 may include any information regarding the retailer 304 including, but not limited to, personal information of the retailer, message board activity of the retailer 304, and any relationship or financial information with the retailer 304. A non-limiting and exemplary embodiment of an entry in the retailer database 320 is generally shown at 600 in FIG. 6.

In accessing or otherwise viewing the enrolled consumers, the host server 302 may be able to select a consumer name to view any content or activity of the consumer 308. The host server 302 may also be able to add or delete enrolled consumers. The enrolled consumers may be stored in a consumer information database 322, as shown in FIG. 3. The consumer information database 322 may include any information regarding the consumer 308 including, but not limited to, personal information of the consumer 308 and message board activity of the consumer 308. The message board activity of the consumer 308 may include retail locations from which the consumer 308 accessed message boards, electronic message boards accessed, dates or times of electronic message boards accessed, and advertisement or loyalties viewed or redeemed. The message board activity may also include additional or alternative information as generally known and understood in the art. A non-limiting and exemplary embodiment of an entry in the consumer information database 322 is generally shown at 700 in FIG. 7.

In accessing or otherwise viewing the active, pending, or closed electronic message boards, the host server 302 may be able to select an electronic message board to view any content or activity relating to the electronic message board. The host server 302 may also be able to activate or delete pending or closed electronic message boards. The active, pending, or closed electronic message boards may be stored in a message board database 324, as shown in FIG. 3. The message board database 324 may include any information regarding content or viewing of an electronic message board.

Any of the host advertisement database 318, the retailer database 320, the consumer information database 322, and the message board database 324 may be private or secure to the host server 302. Alternatively, in embodiments of the present disclosure, any of the host advertisement database 318, the retailer database 320, the consumer information database 322, and the message board database 324 may be open or accessible to any of the retailer 304, the direct advertiser 306, the indirect advertiser, and the consumer 308.

The processes 400 of FIG. 4 may further include an electronic message board creation process 404 for creating the electronic message board. During the electronic message board creation process 404, the host server 302 may receive a request for creation of the electronic message board. The request may be received by the network interface 312 of the host server 302 via the network 310 from the retailer 304. The retailer 304 may access a website of the host server 302, and submit an electronic request for the creation of the electronic message board. The request may include any information as generally known and understood in the art.

According to embodiments of the present disclosure, the host server 302 receives the electronic request from the retailer 304, and creates the electronic message board. The electronic request may require that a payment be submitted prior to creating the electronic message board. The host server 302 may create the electronic message board only after receiving the payment from the retailer 304. In further embodiments, the host server 302 may not require that the payment be submitted with the electronic request, and instead, the host server 302 may charge a fee for use of the electronic message board. Such a fee may be dependent upon a content of the electronic message board, such as, the advertisements, loyalty rewards, or “kicks” pushed to the electronic message board by the host server 302.

Any of the fees related to the creation or use of the electronic message board may be based on any combination of the advertisements, loyalty rewards, or “kicks” pushed to the electronic message board by either the host server 302 from the indirect advertisers, the retailer 304, or the direct advertiser 306. The fees may additionally or alternatively be based upon a setup of the electronic message board, such as a display size, display features, number of pages, number of areas, capacity for advertisements, variability of advertisements, schedule of advertisements, number of indirect advertisers, number of direct advertisers, or any other feature described herein or otherwise commonly known and understood in the art. The above-examples are merely exemplary and are not limiting, exhaustive, or exclusive.

An exemplary electronic message board is generally indicated at 800 in FIG. 8. The electronic message board 800 is shown as being displayed on a computer device 802. Nevertheless, it is to be known and understood that the computer device 802 is merely exemplary and that the electronic message board 800 may additionally be displayed on any other electronic device, including mobile device, described herein. The electronic message board 800 is shown as displaying an advertisement for a special. However, it is also to be known and understood that the advertisement is also merely exemplary and that the advertisement may additionally or alternatively include, for example, a loyalty reward. The electronic message board 800 is also shown as including a single display area and a single advertisement. For example, in the embodiment of FIG. 8, the retailer 304 may be able to make a maximum of seven message boards for each of the seven days of the week. FIG. 8 may show the message board for one of the days. Further message boards, however, may include multiple display areas, pages, and advertisements. The electronic message board 800 is also shown as including text 804 and a photo 806. The text 804 may be of any color, size, alignment, font, style, or other display property. Moreover, the photo 806 may be any type of photo which the host server 302, the retailer 304, or the direct advertiser 306 my upload. Any of the above-described features may be standard features of the electronic message board 800 or may be dependent upon or related to the above-described fees.

The processes 400 of FIG. 4 may further include a retailer administration process 406. The administration access process 406 may be accessible via a website or application and include a secure sign-in process for the retailer 304. Upon a successful sign-in, various options may be presented such as, but not limited to, options for accessing, listing, selecting, or otherwise viewing the direct advertisers, enrolled consumers, and/or active, pending, or closed electronic message boards. Thumbnails of the electronic message boards may be displayed to the retailer 304 to allow the retailer 304 to preview what each message board looks like. The options may also include options for creating, editing, modifying, distributing, newly establishing, or otherwise related to an electronic message board. The options or process may be presented to the retailer 304 via a main screen or homepage of the website or other application. The main screen or homepage may include the following processes or selections: (1) Message Board Creation; (2) Message Board Administration; (3) Direct Advertiser Administration; (4) Direct Advertiser Message Board History; (5) Rewards Administration; and (6) Consumer Information. Of course, these processes or selections are merely exemplary and are not limiting, exhaustive, or exclusive.

An exemplary embodiment of a Message Board Creation process for the retailer 304 is generally shown at 900 of FIG. 9. The Message Board Creation process 900 may include, but is not limited to, any processes or functions whereupon the retailer 304 may create, modify or edit the electronic message board. For example, the retailer 304 may be able to upload an advertisement, loyalty reward, or other marketing materials to the electronic message board. The Message Board Creation process 900 may further include any processes or functions for scheduling or publishing the advertisement, loyalty reward, or other marketing materials to the electronic message board. The Message Board Creation process 900 may even further include controls for limiting or restricting access to the advertisement, loyalty reward, or other marketing materials on the electronic message board, such as, password protection or encryption. The Message Board Creation process 900 may include any processes or functions for creating or otherwise maintaining the electronic message board as generally known and understood in the art. The information regarding the Message Board Creation process 900 may be stored or accessed, for example, in the electronic message board database 318 of the host server 302.

An exemplary embodiment of a Message Board Administration process for the retailer 304 is generally shown at 1000 in FIG. 10. As shown, the Message Board Administration process 1000 may identify each electronic message board of the retailer 304. The electronic message board may include multiple versions, which each correspond to a predetermined day, date, time, or other period. The direct advertiser 306 or vendor associated with each message board may be further indicated. The Message Board Administration process 1000 may require that each direct advertiser 306 or vendor request approval of any advertisement, loyalty reward, or other marketing materials before display on the electronic message board. The direct advertiser 306 may receive an email, text message, or other notification when the direct advertiser 306 or vendor requests approval of any advertisement, loyalty reward, or other marketing materials. The retailer 304 may review and edit the direct advertiser 306 or vendor request, and activate the corresponding advertisement, loyalty reward, or other marketing materials for publication or distribution. The information regarding the Message Board Administration process 1000 may be stored or accessed, for example, in the electronic message board database 318 of the host server 302.

An exemplary embodiment of a Direct Advertiser Administration process for the retailer 304 is generally shown at 1100 in FIG. 11. The Direct Advertiser Administration process 1100 may include any information regarding the direct advertiser 306 including, but not limited to, personal information of the direct advertiser 306 and message board activity of the direct advertiser 306. The message board activity of the direct advertiser 306 may include advertisements, loyalty rewards, or other marketing materials posted per message board per a given time period, and also any revenue received from or generated by the direct advertiser 306. The Direct Advertiser Administration process 1100 may also include additional or alternative information regarding the direct advertiser 306 as generally known and understood in the art, and it may be linked to any of the other processes. The information regarding the Direct Advertiser Administration process 1100 may be stored or accessed, for example, in the advertisement database 318 of the host server 302.

An exemplary embodiment of a Direct Advertiser Message Board History process for the retailer 304 is generally shown at 1200 in FIG. 12. The Direct Advertiser Message Board History process 1200 may include history information regarding the advertisements, loyalty rewards, or other marketing materials of each direct advertiser 306. This information may include the actual advertisement, loyalty reward, or other marketing material, information regarding the electronic message board, a number of views or hits of the advertisement, loyalty reward, or other marketing material, and revenue generated by the advertisement, loyalty reward, or other marketing material, or a number of redemptions of the advertisement, loyalty reward, or other marketing material. Of course, these examples are merely exemplary and are not limiting, exclusive, or exhaustive. The information regarding the Direct Advertiser Message Board History process 1200 may be stored or accessed, for example, in the advertisement database 318 of the host server 302.

An exemplary embodiment of a Rewards Administration process for the retailer 304 is generally shown at 1300 in FIG. 13. This page may include additional or alternative information regarding the advertisements, loyalty rewards, or other marketing materials as described above with regards to the Direct Advertiser Message Board History process 1200. In this regard, while the Direct Advertiser Message Board History process 1200 is generally related to and sorted by the direct advertiser 306, the Rewards Administration process 1300 may generally correspond to the advertisement, loyalty reward, or other marketing material itself. The information regarding the Rewards Administration process 1300 may be stored or accessed, for example, in the advertisement database 318 of the host server 302.

An exemplary embodiment of a Consumer Information process for the retailer 304 is generally shown at 1400 in FIG. 14. This process may include information regarding registered consumers and their activity regarding the electronic message board. The information may be the same or similar to the information as stored in the consumer information database 318. The information regarding the Consumer Information process 1400 may be stored or accessed, for example, in the consumer information database 318 of the host server 302.

The processes 400 of FIG. 4 may further include a direct advertiser 306 access process 408. The direct advertiser 306 access process 408 may be accessible via a website or application and include a secure sign-in process for the direct advertiser 306. Upon a successful sign-in, various options may be presented such as, but not limited to, options for accessing, listing, selecting, or otherwise viewing the enrolled consumers, and/or active, pending, or closed electronic message boards. The options may also include options for creating, editing, modifying, distributing, or otherwise related to an electronic message board. The options or process may be presented to the direct advertiser 306 via a main screen or homepage of the website or other application.

An exemplary embodiment of a Message Board Creation process for the direct advertiser 306 is generally shown at 1500 of FIG. 15. The Message Board Creation process 1500 for the direct advertiser 306 may include, but is not limited to, any processes or functions whereupon the direct advertiser 306 may create, modify or edit the electronic message board. For example, the retailer 304 may be able to upload an advertisement, loyalty reward, or other marketing materials to the electronic message board. The Message Board Creation process 1500 for the direct advertiser 306 may further include any processes or functions for scheduling or publishing the advertisement, loyalty reward, or other marketing materials to the electronic message board. The Message Board Creation process 1500 for the direct advertiser 306 may even further include functions or processes for requesting approval of an advertisement, loyalty reward, or other marketing materials from the retailer 304. The information regarding the Message Board Creation process 1500 for the direct advertiser 306 may be stored or accessed, for example, in the electronic message board database 318 of the host server 302.

The processes 400 of FIG. 4 may further include a consumer access process 410. The consumer 308 may access the electronic message board of the retailer 304 by “checking-in” or “opting-in” to the electronic message board in the retail environment. The consumer 308 may “check-in” or “opt-in” by scanning a code, such as a barcode, Radio Frequency Identification (RFID) code, Quick Response (QR) code, in the retail environment. Additionally or alternatively, the consumer 308 may “check-in” or “opt-in” by accessing a network of the retailer 304. When accessing the network, the consumer 308 may be provided with an option for “checking-in” or “opting-in” to the electronic message board of the retailer 304. Of course, the consumer 308 may “check-in” or “opt-in” to the electronic message board of the retailer 304 via any additional or alternative methods which are known and understood without departing from the scope of the disclosure.

Upon a first time access, the consumer 308 may be provided with a welcome message or greeting. The consumer 308 may be provided with a registration or sign-in process such that the electronic messaging system 300 may track the consumer 308 and a frequency with which he or she visits the electronic message board. The registration process may be a positive process that is executed by the consumer 308, or the electronic messaging system 300 may capture an identifier of the device with which the consumer 308 connects to the electronic message board such that the electronic messaging system 300 may track the consumer 308 independently of his or her actions.

Upon a second and subsequent access, the consumer 308 may be provided with a “welcome back” message or greeting to acknowledge recognition of the consumer 308 for building loyalty with the consumer 308. The electronic messaging system 300 may also log the access of the consumer 308 to the electronic message board for tracking the frequency of the consumer 308. The activity and frequency of the consumer 308 may be stored in the consumer information system 322 of the host server 302.

After the consumer 308 receives the welcoming message or greeting, the consumer 308 may be taken directly to the current message board or the message board of the day. Once there, the consumer 308 may view any advertisement, loyalty reward, or other marketing materials. The electronic message board may simply be a display of the advertisement, loyalty reward, or other marketing materials, or the electronic message board may enable the consumer 308 to post a comment or ask a question to the electronic message board. There may even be a link on the electronic message board whereupon the consumer 308 may “share” the electronic message board. The consumer 308 may be presented with an additional or further loyalty reward for sharing the electronic message board. The above-described features are merely exemplary and not limiting or exhaustive. The electronic message board may include additional ort alternative features as known and understood without departing from the scope of the present disclosure.

The processes 400 of FIG. 4 may further include a distribution process 412 for the advertisements, loyalty rewards, or other marketing materials. The distribution process 412 may control and maintain a schedule with which the advertisements, loyalty rewards, or other marketing materials are released to the electronic message board or made available to the consumer 308. The advertisements, loyalty rewards, or other marketing materials may be distributed in accordance with a predetermined schedule based on date or time. The materials may also be distributed based on geography or other criteria as generally known and understood.

The distribution process 412 may further includes functions or processes for tracking a quantity of distributed materials and a number of views or hits. The distribution process 412 may generate a bill or determine costs based on the distribution of the materials, the number of views or hits, or any combination thereof. The bill may be even further generated based on a quality or desirability of the materials, which may be determined based on a status of the indirect advertiser 306.

Once again, the processes 402-412 of FIG. 4 are merely exemplary and are not limiting, exhaustive, or exclusive. Additional embodiments of the present application may include additional or alternative processes and combinations thereof.

An exemplary process for providing an electronic messaging system in a retail environment is generally shown at 1600 in FIG. 16. The process 1600 may comprise operations which are executed by the host server 302 of FIG. 3. That is, the memory 316 of the host server 302 may comprise executable instructions that, when executed by the processor 314, cause the processor 314 to execute the operations for hosting and maintaining the electronic messaging system 300. The operations of the processor 314 may involve, but are not limited to, the creation, distribution, and termination of the electronic message board. The process 1600 is described with reference to the electronic messaging system 300 of FIG. 3. Nevertheless, it should be known and understood that the process 1600 and electronic messaging system 300 may comprise separate embodiments of the present disclosure.

The host server 302 may create an electronic message board in association with the retailer 304 at S1602. The electronic message board may be created, for example, in accordance with the electronic message board creation process 404 of FIG. 4. The host server 302 may store the electronic message board in the message board database 318. The electronic message board may be accessible to the consumer 308 in a retail environment via the network 310. For example, the consumer 308 may visit the retail environment of the retailer 304, whereupon the consumer 308 may scan a code or access a network of the retailer 304 which directs the consumer 308 to the electronic message board. The consumer 308 may be required to complete a separate registration process in addition to the log-in process for tracking and identifying the consumer 308. The electronic message board is referred to herein in singular form, but it is to be known and understood that the electronic message board may comprise a plurality of electronic message boards. The plurality of electronic message boards may comprise separate pages, or may include different boards which are displaying based upon predetermined conditions, such as a day of the week.

The host server 302 determines a host advertisement in association with the retailer 304 at S1604. The host advertisement may be determined from among host advertisements stored in the host advertisement database 318. The host advertisement database 318 includes the host advertisements which are advertisements of a plurality of “indirect” advertisers obtained by the host server 302. The indirect advertisers may be super brands with whom the host server 302 has established relationships for distributing their advertisements. Their advertisements may be distributed by the host server 302 independently of any action on the part of the indirect advertisers. The host server 302 may determine which advertisement to distribute in accordance with the retailer 304 based on the relationships with the indirect advertisers, or based on conditions established within the relationships. Additionally, or alternatively, the host server 302 may determine the advertisements based on a geographic location of the retailer 304 environment, or based on a product or service offered by the retailer. In further embodiments of the present disclosure, the host server 302 may determine the host advertisement based on the consumer 308 which is associated or registered with the retailer 304. In even further embodiments, the host server 302 may determine the advertisement in accordance with any additional or alternative methods which are generally known and understood in the art.

The host server 302 displays the advertisement on the electronic message board at S1606, and may make the electronic message board including the host advertisement available to the consumer 308 in the retail environment in accordance with the distribution process 412 of FIG. 4.

The host server 302 further provides the retailer 304 with retailer access controls which enable the retailer 304 to access and control a content of the electronic message board at S1608. The retailer access controls enable the retailer 304 to provide advertiser access controls to a direct advertiser 306 obtained by the retailer 304. The “direct” advertiser is distinct and distinguished from the indirect advertisers in that the retailer 304 is able to contact and form the relationship with the direct advertiser 306. As a result, the retailer 304 is able to generate revenue or receive compensation from the direct advertiser 306 independently of the host server 302. Moreover, the retailer 304 is able to seek and obtain advertisement or other materials which it desires or determines to be appropriate. Thus, the retailer 304 is provided with greater control over the content of the electronic message board.

The advertiser access controls enable the direct advertiser 306 to access and control the content of the electronic message board. In other words, the advertiser access controls enable the direct advertiser 306 to access the electronic message board and to upload or add content to the electronic message board, as described by the direct advertiser 306 access process 408 of FIG. 4. In exchange for the revenue or compensation provided to the retailer 304, the direct advertiser 306 is able to provide its advertising or other materials to the consumer 308. Thus, the advertiser receives a new advertising channel.

The advertiser access controls are generally different than the retailer access controls. That is, the advertiser access controls may limit the direct advertiser 306 to creating preliminary or draft advertisements, which must be approved by the retailer 304 before being uploaded to the electronic message board or distributed to the consumer 308. The advertiser access controls may also include different or limited advertisement upload privileges or rights. For example, the advertiser access controls may limit the format or style of advertisements which may be uploaded, such as limiting a font or color of the advertisements or limiting the uploading or displaying to only text or images. The retailer access controls, on the other hand, may enable the retailer 304 to upload or display any text or colors and to also upload videos to the electronic message board. Such features enable the retailer 304, and even the host server 302, to control a focus and presentation of the electronic message board and to also control a bandwidth of the electronic message board. The advertiser access controls may additionally or alternatively restrict or limit the content that the direct advertiser 306 is able to upload. For example, the direct advertiser 306 may be restricted or prevented from uploading links. This may prevent the direct advertiser 306 from diverting traffic away from the retailer 304 and the processor 314. The advertiser access controls may also restrict or prevent the direct advertiser 306 from uploading or distributing loyalty rewards. The advertiser access controls may solely permit the direct advertiser 306 to upload and distribute advertisement. This may enable the retailer 304 to prevent the distribution of unwarranted rewards and specials. The retailer access controls may also be different from the advertiser access controls in that they enable access to the retailer 304 to any of the databases 318, 320, 322, 322 of the host server 302. The above examples are merely exemplary and not exhaustive or exclusive. The advertiser access controls may be further different from the retailer access controls in additional or alternative means, as described herein, without departing from the scope of the present disclosure.

The retailer access controls may enable the retailer 304 to variably provide the advertiser access controls to the direct advertiser 306 to limit the access and control of the electronic message board by the direct advertiser 306. That is, the retailer 304 may determine a level of control or restriction that is to be provided to the direct advertiser 306. For example, the retailer 304 may provide the direct advertiser 306 with access and control of the content of the electronic message board on only certain days of the week. This enables the retailer 304 to establish multiple relationships with multiple direct advertisers 306. It also enables the retailer 304 to charge variable pricing for different direct advertisers 306, depending on the desirability of their advertiser access controls.

With respect to the variability of the advertiser access controls, the advertiser access controls may spatially limit the direct advertiser 306 to accessing and controlling a predetermined portion of the electronic message board. That is, the advertiser access controls may restrict the direct advertiser 306 to providing advertisements or other materials within a limited space of the electronic message board. The limited space may comprise a predetermined area or page of the electronic message board. In this regard, the limited space may be fixed or constant, or the limited space may even be variable depending on a viewing rate or redemption of the advertisement or reward of the direct advertiser 306.

The advertiser access controls may additionally or alternatively geographically limit the direct advertiser 306 to accessing and controlling the electronic message board within a predetermined area. For example, the advertiser access controls may limit the direct advertiser 306 to only advertising at certain geographic locations of the retailer 304. This enables the retailer 304 to charge higher pricing for its more desirable locations which may have higher foot traffic or affluency.

The advertiser access controls may additionally or alternatively temporally limit the direct advertiser 306 to accessing and controlling the electronic message board during a predetermined period. For example, as discussed above, the advertiser access controls may limit the direct advertiser 306 to advertising on a particular day of the week or during a certain time of day. This enables the retailer 304 to customize the advertisements based on daily specials and business level. It also enables the retailer 304 to charge higher pricing for its more desirable time periods.

The advertiser access controls may additionally or alternatively quantitatively limit the direct advertiser 306 to accessing and controlling the electronic message board a predetermined number of times. That is, the advertiser may be limited to displaying a predetermined number of advertisements. Each advertisement may run for a day, for example. The direct advertiser 306 may purchase a limited quantity of advertisements and determine when and where to run the advertisements. This enables the retailer 304 to charge bundle pricing.

The advertiser access controls may additionally or alternatively quantitatively limit the content controlled by the advertiser to being accessed by a predetermined number of consumers. In this regard, the distribution process 412 of the host server 302 may track the number of consumers which view or log-in to the electronic message board. The advertiser access controls may limit an advertisement or loyalty reward to being viewed or redeemed by a predetermined number of consumers. As a result, the retailer 304 or direct advertiser 306 may limit a number of rewards offered to the consumers 308. Variable pricing may also be established for the advertiser access controls such that the direct advertiser 306 may reach a predetermined or target number of consumers.

The above-described limitations and restrictions are generally described with respect to accessing and controlling the electronic message board. In this regard, the access and controlling may refer to the physical accessing of the website which controls the content of the electronic message board, as generally shown by FIG. 15. Additionally or alternatively, the access and controlling may refer to the actual distribution or publication of the electronic message board. That is, the direct retailer 304 may upload content for the electronic message board at any time, but the distribution or publication of the content to the electronic message board may be limited in accordance with the above-described criteria and features.

In an embodiment of the process 1600, the host server 302 may notify the retailer 304 when the content of the electronic message board is modified by the direct advertiser 306 to include a direct advertiser advertisement at S1610. According to such a feature, the retailer 304 may monitor the content of the direct advertiser 306 to maintain the integrity of the electronic message board. The host server 302 may upload or display the direct advertiser advertisement on the electronic message board only in response to the receiver approving the direct advertiser advertisement. The host server 302 may display the direct advertiser advertisement on the electronic message board in response to the host server 302 receiving an acceptance of the direct advertiser advertisement from the retailer 304 at S1612.

In another embodiment of the process 1600, the host server 302 may notify the retailer 304 when the content of the electronic message board is modified by the direct advertiser 306 to include a direct advertiser advertisement at S1614. The retailer access controls may enable the advertiser to approve, edit, or otherwise modify the direct advertiser advertisement. The host server 302 may receive a modification of the direct advertiser advertisement from the retailer 304 after notifying the retailer 304 of the direct advertiser advertisement at S1616.

In an even further embodiment of the process, the host server 302 receives an access request from the consumer 308 via a log-in process at S1618. The host server 302 may require an authentication of the access request from the consumer 308 at S1620. The authentication may be performed using any stored or registered information of the consumer 308. The information may be stored, for example, in the consumer information database 322. The authentication may be performed in accordance with any known and understood methods and means without departing from the scope of the present disclosure.

In any event the host server 302 publishes, displays, or otherwise makes available the electronic message board at S1622. The displayed electronic message board may include the host advertisement of the indirect advertiser, and any advertisement, loyalty, or other marketing materials of the retailer 304. The displayed electronic message board may further include any advertisement of the direct advertiser 306, with or without the modification from the retailer 304. The displayed electronic message board may include, for example, a loyalty reward for the consumer 308. The loyalty reward may be displayed in response to the consumer 308 logging-in to or accessing the electronic message board. Alternatively, the electronic message board may be interactive with the consumer 308 and display the loyalty reward in response to a predetermined condition being satisfied. Such predetermined conditions are described, for example, in U.S. patent application Ser. No. 13/048,087.

In an embodiment of the present disclosure as generally shown at 1700 in FIG. 17, an electronic message board 1702 may include a first area 1704 and a second area 1706. The first area 1704 may be accessible to the host server 1708 for displaying the host advertisement of the indirect advertiser 1710. The second area 1706 may be accessible to the retailer 1712 via the retailer access controls and also accessible to the direct advertiser 1714 via the advertiser access controls. The retailer 1712 and the direct advertiser 1714 may each control the content of the electronic message board 1702 via the second area 1706. According to such an embodiment, the host server 1708 may independently control the first area 1704. In this regard, the retailer access controls and the advertiser access controls may be limited to accessing and controlling the content of the electronic message board 1702 only in the second area 1706. Moreover, the retailer 1712 and the direct advertiser 1714 may control the second area 1706 independently of the host server 1708. The retailer access controls and the advertiser access controls may be equal or different for the second area 1706.

According to such an embodiment 1700, host access controls of the host server may be different than both the retailer access controls and the advertiser access controls. In other words, the retailer access controls provide the retailer 1712 with access to only the second area 1706 of the electronic message board 1702 for limiting control of the content of the electronic message board 1702 by the retailer 1712 to only the second area 1706. This may protect the integrity of the first area 1704 and facilitate maintaining of the relationships between the host server 1708 and the indirect advertisers 1710. In addition, the host server 1708 may have access to only the first area 1704 of the electronic message board 1702 for limiting a display of the host advertisement to only the first area 1704. This protects the virtual space of the retailer 1712, and enables the retailer 1712 to maximize its revenue generated from the direct advertiser 1714. Moreover, it also separates the relationship between the retailer 1712 and the direct advertiser 1714 from the host server 1708. In this regard, the advertiser access controls may enable the direct advertiser 1714 to access and control the content of the electronic message board 1702 independently of the host server 1708. In any event, in any of the above-embodiments 1700, the consumer 1716 may access and view each of the first area 1704 and the second area 1706 of the electronic message board 1702.

In a variation of the embodiment 1700 of FIG. 17, the retailer 1712 may be further provided with access and control to the first area 1704. In this regard, the retailer 1712 may regulate, edit, modify, or otherwise control the content of the first area 1704, including the host advertisement of the indirect advertiser 1710. The retailer 1712 may have equal access and control of the first area 1704, or the retailer 1712 may have limited or restricted access to the first area 1704 when compared with the host server 1708. For example, the retailer 1712 may be limited from editing, modifying, or otherwise controlling the host advertisement to protect an integrity of the host advertisement and maintain the relationship between the host server 1708 and the indirect advertiser 1710.

In a further embodiment of the present disclosure as generally shown at 1800 in FIG. 18, an electronic message board 1802 may include a first area 1804 and a second area 1806/1808. The second area 1806/1808 may include a retailer area 1806 and an advertiser area 1808. According to such an embodiment 1800, the host server 1810 may independently control the first area 1804 for display of its host advertisement of the indirect advertiser 1812, the retailer 1814 may independently control the retailer area 1806, and the direct advertiser 1816 may independently control the advertiser area 1808. According to such an embodiment 1800, each of the host access controls, retailer access controls, and advertiser access controls may be different and do not include any overlap. In any event, the consumer 1818 may access and view each of the first area 1804, the retailer area 1806, and the advertiser area 1808 of the electronic message board 1802.

In a variation of the embodiment 1800 of FIG. 18, the advertiser area 1808 may be further accessible to the retailer 1814 via the retailer access controls. In this regard, the retailer access controls include overlap with the advertiser access controls. This enables the retailer 1814 to control the content of the electronic message board 1802 via the retailer area 1806 and the advertiser area 1808. Moreover, the advertiser access controls may provide the direct advertiser 1816 with access to only the advertiser area 1808 of the electronic message board 1802 for limiting control of the content of the electronic message board 1802 by the direct advertiser 1816 to only the advertiser area 1808.

In a further variation of the embodiment 1800 of FIG. 18, or any of the other embodiments described herein, the advertiser area 1808 may include a plurality of advertiser areas 1808. The retailer access controls may enable the retailer 1814 to provide the advertiser access controls to a plurality of direct advertisers 1816 obtained by the retailer 1814. The advertiser access controls of each of the plurality of direct advertisers 1816 may enable access and control of the content of the electronic message board 1802 via a corresponding one of the plurality of advertiser areas 1808. That is, each of the direct advertisers 1816 may be assigned their own advertiser area 1808.

Of course, those skilled in the art appreciate that the above-described method 1500 is merely exemplary and that the present disclosure includes various additional and alternative methods in accordance with the teachings and disclosure set forth herein. Moreover, those of ordinary skill in the art understand the various processes and methods described herein may be implemented by various computer programs and computer-readable media including executable instructions. The computer programs and computer-readable media, when executed, may implement any of the various processes, methods, or combinations thereof disclosed herein.

Accordingly, the present disclosure provides various systems, servers, methods, media, and programs for providing an information exchange session. Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A host server for providing an electronic messaging system in a retail environment, the host server comprising:
a host processor; and
a host memory including instructions that, when executed by the host processor, cause the host processor to execute operations comprising:
creating an electronic message board in association with a retailer, the electronic message board being stored in a message board database and being accessible in the retail environment to a consumer via a log-in process;
determining a host advertisement in association with the retailer, the host advertisement being stored in a host advertisement database that includes advertisements of a plurality of indirect advertisers obtained by the host server;
displaying the host advertisement on the electronic message board;
providing the retailer with retailer access controls which enable the retailer to access and control a content of the electronic message board,
wherein the retailer access controls enable the retailer to provide advertiser access controls to a direct advertiser obtained by the retailer, the advertiser access controls enabling the direct advertiser to access and control the content of the electronic message board, the advertiser access controls being different than the retailer access controls.

2. The host server according to claim 1, wherein the electronic message board comprises:
a first area that is accessible to the host processor for displaying the host advertisement; and
a second area that is accessible to the retailer via the retailer access controls and accessible to the direct advertiser via the advertiser access controls, the retailer and the direct advertiser each controlling the content of the electronic message board via the second area.

3. The host server according to claim 2, wherein the second area of the electronic message board comprises:
a retailer area that is accessible to the retailer via the retailer access controls, the retailer controlling the content of the electronic message board via the retailer area; and
an advertiser area that is accessible to the direct advertiser via the advertiser access controls, the advertiser controlling the content of the electronic message board via the advertiser area.

4. The host server according to claim 3, wherein the advertiser area is further accessible to the retailer via the retailer access controls, the retailer controlling the content of the electronic message board via the retailer area and the advertiser area.

5. The host server according to claim 3, wherein the advertiser access controls provide the direct advertiser with access to only the advertiser area of the electronic message board for limiting control of the content of the electronic message board by the direct advertiser to only the advertiser area.

6. The host server according to claim 3, wherein
the advertiser area includes a plurality of advertiser areas,
the retailer access controls enable the retailer to provide the advertiser access controls to a plurality of direct advertisers obtained by the retailer, and
the advertiser access controls of each of the plurality of direct advertisers enable access and control of the content of the electronic message board via a corresponding one of the plurality of advertiser areas.

7. The host server according to claim 2, wherein the retailer access controls for the second area are different than the advertiser access controls for the second area.

8. The host server according to claim 2, wherein the retailer access controls for the second area are equal to the advertiser access controls for the second area.

9. The host server according to claim 2, wherein the retailer access controls enable the retailer to access and control the first area of the electronic message board.

10. The host server according to claim 2, wherein the retailer access controls provide the retailer with access to only the second area of the electronic message board for limiting control of the content of the electronic message board by the retailer to only the second area.

11. The host server according to claim 1, wherein the advertiser access controls enable the direct advertiser to access and control the content of the electronic message board independently of the host server.

12. The host server according to claim 1, wherein the retailer access controls enable the retailer to variably provide the advertiser access controls to the direct advertiser to limit the access and control of the electronic message board by the direct advertiser.

13. The host server according to claim 12, wherein the advertiser access controls spatially limit the direct advertiser to accessing and controlling a predetermined portion of the electronic message board.

14. The host server according to claim 12, wherein the advertiser access controls temporally limit the direct advertiser to accessing and controlling the electronic message board during a predetermined period.

15. The host server according to claim 12, wherein the advertiser access controls quantitatively limit the direct advertiser to accessing and controlling the electronic message board a predetermined number of times.

16. The host server according to claim 1, wherein the operations further comprise:
notifying the retailer when the content of the electronic message board is modified by the direct advertiser to include a direct advertiser advertisement.

17. The host server according to claim 16, wherein the operations further comprise:
displaying the direct advertiser advertisement on the electronic message board only in response to receiving an acceptance of the direct advertiser advertisement from the retailer.

18. The host server according to claim 16, wherein the operations further comprise:
receiving a modification of the direct advertiser advertisement from the retailer after notifying the retailer of the direct advertiser advertisement; and
displaying the direct advertiser advertisement with the modification on the electronic message board in response to the receiving of the modification.

19. The host server according to claim 1, wherein the electronic message board comprises a plurality of electronic message boards.

20. The host server according to claim 19, wherein the advertiser access controls provide each of a plurality of direct advertisers with access and control to one of the plurality of electronic message boards.

21. The host server according to claim 1, wherein the operations further comprise:
receiving an access request from the consumer via the log-in process; and
providing the electronic message board including the host advertisement and the content controlled by the retailer and the direct advertiser to the consumer in response to the receiving of the access request.

22. The host server according to claim 21, wherein the operations further comprise:
authenticating the access request from the consumer using consumer information stored in a consumer information database.

23. The host server according to claim 22, wherein the retailer access controls further provide access to the consumer information database.

24. The host server according to claim 21, wherein the operations further comprise:
displaying a loyalty reward for the consumer on the electronic message board in response to the receiving of the access request.

25. The host server according to claim 1, wherein the operations further comprise:
tracking a display of the host advertisement and the control of the content of the electronic message board by each of the retailer and the direct advertiser for determining an advertising flow through the electronic message board.

26. A method for providing an electronic messaging system in a retail environment, comprising:
creating an electronic message board in association with a retailer;
storing the electronic message board in a message board database, the electronic message board being accessible in the retail environment to a consumer via a log-in process;
determining, with a processor, a host advertisement in association with the retailer, the host advertisement being stored in a host advertisement database that includes advertisements of a plurality of indirect advertisers obtained by the host server;
displaying the host advertisement on the electronic message board;
providing the retailer with retailer access controls which enable the retailer to access and control a content of the electronic message board,
wherein the retailer access controls enable the retailer to provide advertiser access controls to a direct advertiser obtained by the retailer, the advertiser access controls enabling the direct advertiser to access and control the content of the electronic message board, the advertiser access controls being different than the retailer access controls.

27. The method according to claim 26, wherein the electronic message board comprises:
a first area that is accessible to the host processor for displaying the host advertisement; and
a second area that is accessible to the retailer via the retailer access controls and accessible to the direct advertiser via the advertiser access controls, the retailer and the direct advertiser each controlling the content of the electronic message board via the second area.

28. A non-transitory computer readable medium including an executable set of instructions for providing an electronic messaging system in a retail environment that, when executed by a processor, causes the processor to execute operations comprising:
creating an electronic message board in association with a retailer;
storing the electronic message board in a message board database, the electronic message board being accessible in the retail environment to a consumer via a log-in process;
determining a host advertisement in association with the retailer, the host advertisement being stored in a host advertisement database that includes advertisements of a plurality of indirect advertisers obtained by the host server;
displaying the host advertisement on the electronic message board;
providing the retailer with retailer access controls which enable the retailer to access and control a content of the electronic message board,
wherein the retailer access controls enable the retailer to provide advertiser access controls to a direct advertiser obtained by the retailer, the advertiser access controls enabling the direct advertiser to access and control the content of the electronic message board, the advertiser access controls being different than the retailer access controls.

29. The non-transitory computer readable medium according to claim 28, wherein the electronic message board comprises:
a first area that is accessible to the host processor for displaying the host advertisement; and
a second area that is accessible to the retailer via the retailer access controls and accessible to the direct advertiser via the advertiser access controls, the retailer and the direct advertiser each controlling the content of the electronic message board via the second area.
